(19) United States
(12) Patent Application Publication
(10) Pub. No.: US 2026/0080768 A1
(43) Pub. Date: Mar. 19, 2026

(54) Fire Early Detection System

(71) Applicant: OSCILLOS LLC, Arecibo, PR (US)

(72) Inventors: Berny Rafael Bravo Sierra, Troy, MI (US); Joseph E Medina Molina, ARECIBO, PR (US); Pedro J Aponte Rolon, Aibonito, PR (US)

(21) Appl. No.: 18/750,431

(22) Filed: Jun. 21, 2024

(51) Int. Cl. G08B 25/10; G01D 21/02; G08B 17/00; H04R 3/04

(52) U.S. Cl. CPC G08B 25/10; G01D 21/02; G08B 17/00; H04R 3/04; H04R 2420/07

(57) ABSTRACT

A fire early detection system (FEDS) is disclosed for use with a gateway device. The FDS includes: a sensory node configured to be disposed at a location; and a warning system configured to receive a detection signal from a gateway device and to output a fire warning signal based on the detection signal. The sensory node includes: a sensor configured to detect a parameter of an environment surrounding the sensory node at the location and to output a parameter signal based on the detected parameter; a communicator configured to wirelessly transmit the detection signal; a memory; a processor configured to execute instructions stored in the memory to: generate, based on the parameter signal, the detection signal; and cause the communicator to wirelessly transmit the detection signal; and a power source configured to supply power to the sensor, the communicator, the memory and the processor.

### BACKGROUND OF THE INVENTION

The present disclosure generally relates to fire early detection systems and methods.

Fire early detection systems are technologies that aim to identify and alert authorities about fires in their early stages, before they can grow into large, uncontrolled blazes. The goal of fire early detection is to catch fires in their infancy, when they are still small and manageable, in order to prevent them from growing into large, destructive fires that can devastate communities. These systems are particularly valuable for monitoring remote, hard-to-access areas where fires can easily go unnoticed for hours or days.

Some problems and limitations of conventional fire early detection systems include reliance on human operators, potential for false alarms, and lack of automated, real-time analysis. With respect to reliance on human operators, many current early detection systems, such as those using thermographic cameras, still rely heavily on human operators to analyze the data and assess the threat, adding subjectivity and latency. With respect to potential for false alarms, there is a risk of false alarms with some sensor technologies, which could divert valuable resources to respond to non-existent threats. With respect to lack of automated, real-time analysis, existing fire detection algorithms are not optimized for the rapid, automated identification of new ignitions and fire intensification, as required by first responders.

There exists a need for a system and method for fire early detection that mitigates reliance on human operators, potential for false alarms, and lack of automated, real-time analysis.

### SUMMARY OF THE INVENTION

An aspect of the present disclosure is drawn to a fire early detection system (FEDS) for use with a gateway device. The gateway device may be configured to wirelessly receive a detection signal via a first communication protocol and to communicate via a network communication protocol. The FEDS includes: a sensory node configured to be disposed at a location; and a warning system configured to receive the detection signal from the gateway device via the network communication protocol and to output a fire warning signal based on the detection signal. The sensory node includes: a sensor configured to detect a parameter of an environment surrounding the sensory node at the location and to output a parameter signal based on the detected parameter; a communicator configured to wirelessly transmit the detection signal; a memory having instructions stored therein; a processor configured to execute the instructions stored in the memory to: generate, based on the parameter signal, the detection signal; and cause the communicator to wirelessly transmit the detection signal; and a power source configured to supply power to the sensor, the communicator, the memory and the processor.

In some embodiments of this aspect, the sensor is configured to detect the parameter as one of a group of parameters including sound volume, sound frequency composition, temperature, pressure, humidity, gas composition, wind magnitude, wind direction, change in sound volume, change in sound frequency composition, change in temperature, change in pressure, change in humidity, change in gas composition, change in wind magnitude, change in wind direction, and combinations thereof.

In some embodiments of this aspect, the sensory node further includes: a second sensor configured to detect a second parameter of the environment surrounding the sensory node at the location and to output a second parameter signal based on the detected second parameter, wherein the processor is further configured to execute the instructions stored in the memory to generate, based on the parameter signal and the second parameter signal, the detection signal, wherein the power source is further configured to supply power to the second sensor, wherein the sensor is configured to detect the parameter as one of a group of parameters including sound volume, sound frequency composition, temperature, pressure, humidity, gas composition, wind magnitude, wind direction, change in sound volume, change in sound frequency composition, change in temperature, change in pressure, change in humidity, change in gas composition, change in wind magnitude, change in wind direction, and combinations thereof, and wherein the second sensor is configured to detect the second parameter as another one of the group of parameters.

In some embodiments of this aspect, wherein the gateway device is additionally configured to wirelessly receive a second detection signal via the first communication protocol, wherein the warning system may be additionally configured to output a second fire warning signal based on the second detection signal, the FEDS further includes: a second sensory node configured to be disposed at a second location, the second sensory node including: a second sensor configured to detect a second parameter of an environment surrounding the second sensory node at the second location and to output a second parameter signal based on the detected second parameter; a second communicator configured to wirelessly transmit the second detection signal; a second memory having second instructions stored therein; a second processor configured to execute the second instructions stored in the second memory to: generate, based on the second parameter signal, the second detection signal; and cause the second communicator to wirelessly transmit the second detection signal; and a second power source configured to supply power to the second sensor, the second communicator, the second memory and the second processor. In some of these embodiments, the communicator is additionally configured to wirelessly receive the second detection signal and to transmit the second detection signal, the second communicator is additionally configured to wirelessly receive the detection signal and to transmit the detection signal, the processor is additionally configured to execute the instructions stored in the memory to cause the communicator to wirelessly transmit the second detection signal, and the second processor is additionally configured to execute the second instructions stored in the second memory to cause the second communicator to wirelessly transmit the detection signal.

In some embodiments of this aspect, the sensor includes a microphone configured to detect sound, as the parameter, of the environment surrounding the sensory node at the location and to output an audio signal as the parameter signal, and the processor is additionally configured to execute the instructions stored in the memory to generate the detection signal by band-pass filtering the audio signal to eliminate any frequencies above 10 KHz and any frequencies below 100 Hz.

In some embodiments of this aspect, the power source is selected from the group of power sources including a battery, a capacitor, an energy harvesting system, a generator, and combinations thereof.

Another aspect of the present disclosure is drawn to a method of detecting and warning of a fire. The method includes: detecting, via a sensor of a sensory node disposed at a location, a parameter of an environment surrounding the sensory node at the location; outputting, via the sensor, a parameter signal based on the detected parameter; generating, via a processor configured to execute instructions stored in a memory, based on the parameter signal, a detection signal; causing, via the processor, a communicator to wirelessly transmit the detection signal to a gateway device; supplying power, via a power source, to the sensor, the communicator, the memory and the processor; wirelessly receiving, via a gateway device, the detection signal via a first communication protocol; communicating, via the gateway device, with a warning system via a network communication protocol; and outputting, via the warning system, a warning signal based on the detection signal.

In some embodiments of this aspect, the detecting the parameter of the environment surrounding the sensory node at the location includes detecting the parameter as one of a group of parameters including sound volume, sound frequency composition, temperature, pressure, humidity, gas composition, wind magnitude, wind direction, change in sound volume, change in sound frequency composition, change in temperature, change in pressure, change in humidity, change in gas composition, change in wind magnitude, change in wind direction, and combinations thereof.

In some embodiments of this aspect, the method further includes: detecting, via a second sensor of the sensory node disposed at the location, a second parameter of the environment surrounding the sensory node at the location; outputting, via the second sensor, a second parameter signal based on the detected second parameter; generating, via the processor, based on the parameter signal and the second parameter signal, the detection signal; and supplying power, via the power source, to the second sensor, wherein the detecting the parameter of the environment surrounding the sensory node at the location includes detecting the parameter as one of a group of parameters including sound volume, sound frequency composition, temperature, pressure, humidity, gas composition, wind magnitude, wind direction, change in sound volume, change in sound frequency composition, change in temperature, change in pressure, change in humidity, change in gas composition, change in wind magnitude, change in wind direction, and combinations thereof, and wherein the detecting, via the second sensor of the sensory node disposed at the location, the second parameter of the environment surrounding the sensory node at the location including the second parameter as another one of the group of parameters.

In some embodiments of this aspect, the method further includes: detecting, via a second sensor of a second sensory node disposed at a second location, a second parameter of an environment surrounding the second sensory node at the second location; outputting, via the second sensor, a second parameter signal based on the detected second parameter; generating, via a second processor configured to execute instructions stored in a second memory, based on the second parameter signal, a second detection signal; causing, via the second processor, a second communicator to wirelessly transmit the second detection signal; and supplying power, via a second power source, to the second sensor, the second communicator, the second memory and the second processor. In some of these embodiments, the method further includes: wirelessly receiving, via the communicator, the second detection signal; and wirelessly transmitting, via the communicator, the second detection signal.

In some embodiments of this aspect, the detecting, via the sensor of the sensory node disposed at the location, the parameter of the environment surrounding the sensory node at the location includes: detecting, via a microphone, sound as the parameter, of the environment surrounding the sensory node at the location; and outputting, via the microphone, an audio signal as the parameter signal, and the generating, via the processor, the detection signal includes generating the detection signal by band-pass filtering the audio signal to eliminate any frequencies above 10 KHz and any frequencies below 100 Hz.

In some embodiments of this aspect, the supplying power, via the power source, to the sensor, the communicator, the memory and the processor includes supplying power via the power source being selected from the group of power sources including a battery, a capacitor, an energy harvesting system, a generator, and combinations thereof.

Another aspect of the present disclosure is drawn to a non-transitory, computer-readable media having computer-readable instructions stored thereon, the computer-readable instructions being capable of being read by a FEDS to perform the method including: detecting, via a sensor of a sensory node disposed at a location, a parameter of an environment surrounding the sensory node at the location; outputting, via the sensor, a parameter signal based on the detected parameter; generating, via a processor configured to execute instructions stored in a memory, based on the parameter signal, a detection signal; causing, via the processor, a communicator to wirelessly transmit the detection signal to a gateway device; supplying power, via a power source, to the sensor, the communicator, the memory and the processor; wirelessly receiving, via the gateway device, the detection signal via a first communication protocol; communicating, via the gateway device, with a warning system via a network communication protocol; and outputting, via the warning system, the warning signal based on the detection signal.

In some embodiments of this aspect, the computer-readable instructions are capable of instructing the FEDS to perform the method wherein the detecting the parameter of the environment surrounding the sensory node at the location includes detecting the parameter as one of a group of parameters including sound volume, sound frequency composition, temperature, pressure, humidity, gas composition, wind magnitude, wind direction, change in sound volume, change in sound frequency composition, change in temperature, change in pressure, change in humidity, change in gas composition, change in wind magnitude, change in wind direction, and combinations thereof.

In some embodiments of this aspect, the computer-readable instructions are capable of instructing the FEDS to perform the method further including: detecting, via a second sensor of the sensory node disposed at the location, a second parameter of the environment surrounding the sensory node at the location; outputting, via the second sensor, a second parameter signal based on the detected second parameter; generating, via the processor, based on the parameter signal and the second parameter signal, the detection signal; and supplying power, via the power source, to the second sensor, wherein the detecting the parameter of the environment surrounding the sensory node at the location includes detecting the parameter as one of a group of parameters including sound volume, sound frequency composition, temperature, pressure, humidity, gas composition, wind magnitude, wind direction, change in sound volume, change in sound frequency composition, change in temperature, change in pressure, change in humidity, change in gas composition, change in wind magnitude, change in wind direction, and combinations thereof, and wherein the detecting, via the second sensor of the sensory node disposed at the location, the second parameter of the environment surrounding the sensory node at the location including the second parameter as another one of the group of parameters.

In some embodiments of this aspect, the computer-readable instructions are capable of instructing the FEDS to perform the method further including: detecting, via a second sensor of a second sensory node disposed at a second location, a second parameter of an environment surrounding the second sensory node at the second location; outputting, via the second sensor, a second parameter signal based on the detected second parameter; generating, via a second processor configured to execute instructions stored in a second memory, based on the second parameter signal, a second detection signal; causing, via the second processor, a second communicator to wirelessly transmit the second detection signal; and supplying power, via a second power source, to the second sensor, the second communicator, the second memory and the second processor. In some of these embodiments, the computer-readable instructions are capable of instructing the FEDS to perform the method further including: wirelessly receiving, via the communicator, the second detection signal; and wirelessly transmitting, via the communicator, the second detection signal.

In some embodiments of this aspect, the computer-readable instructions are capable of instructing the FEDS to perform the method wherein the detecting, via the sensor of the sensory node disposed at the location, the parameter of the environment surrounding the sensory node at the location includes: detecting, via a microphone, sound as the parameter, of the environment surrounding the sensory node at the location; and outputting, via the microphone, an audio signal as the parameter signal, and wherein the generating, via the processor, the detection signal includes generating the detection signal by band-pass filtering the audio signal to eliminate any frequencies above 10 KHz and any frequencies below 100 Hz.

### BRIEF DESCRIPTION OF THE DRAWINGS

The accompanying drawings, which are incorporated in and form a part of the specification, illustrate example embodiments and, together with the description, serve to explain the principles of the disclosure. A brief summary of the drawings follows.

FIG. 1 illustrates an example FEDS in accordance with aspects of the present disclosure.

FIG. 2 illustrates an example method of early detection of fires in accordance with aspects of the present disclosure.

FIG. 3 illustrates a black box diagram of an example sensory node of the FEDS of FIG. 1.

FIG. 4 illustrates an example of plurality of sensors in accordance with aspects of the present disclosure.

FIG. 5 illustrates data of a parameter signal and data of a detection signal in accordance with aspects of the present disclosure.

FIG. 6A illustrates an example FEDS in accordance with aspects of the present disclosure, wherein a sensory node transmits information directly to a gateway device in order to detect a fire.

FIG. 6B illustrates an example FEDS in accordance with aspects of the present disclosure, wherein a sensory node transmits information to a gateway device via a mesh network of nodes in order to detect a fire.

FIG. 7A illustrates an example FEDS in accordance with aspects of the present disclosure, wherein a sensory node transmits information to a gateway device via a wide area network in order to detect a fire.

FIG. 7B illustrates an example FEDS in accordance with aspects of the present disclosure, wherein a sensory node transmits information to a gateway device via a mesh network of nodes and via a wide area network in order to detect a fire.

FIG. 8A illustrates an example FEDS in accordance with aspects of the present disclosure, wherein a sensory node transmits information to a gateway device via a wide area network and a cellular network in order to detect a fire.

FIG. 8B illustrates an example FEDS in accordance with aspects of the present disclosure, wherein a sensory node transmits information to a gateway device via a mesh network of nodes and via a wide area network and a cellular network in order to detect a fire.

FIG. 9 illustrates a black box diagram of an example gateway device of the FEDS of FIG. 1.

FIG. 10 illustrates an example FEDS in accordance with aspects of the present disclosure, wherein a gateway device transmits information to a warning system.

FIG. 11 illustrates a black box diagram of an example warning system of the FEDS of FIG. 1.

FIG. 12 illustrates data of a warning signal.

FIG. 13A illustrates an example FEDS in accordance with aspects of the present disclosure, wherein a warning system transmits a warning signal directly to emergency services.

FIG. 13B illustrates an example FEDS in accordance with aspects of the present disclosure, wherein a warning system transmits a warning signal to emergency services via a cellular network.

FIG. 13C illustrates an example FEDS in accordance with aspects of the present disclosure, wherein a warning system transmits a warning signal to emergency services via a cellular network and a wide area network.

FIG. 13D illustrates an example FEDS in accordance with aspects of the present disclosure, wherein a warning system transmits a warning signal to emergency services via a wide area network and a cellular network.

FIG. 13E illustrates an example FEDS in accordance with aspects of the present disclosure, wherein a warning system transmits a warning signal to emergency services via a wide area network.

### DETAILED DESCRIPTION OF THE EMBODIMENTS

The present disclosure describes a system and method for fire early detection that mitigates reliance on human operators, potential for false alarms, and lack of automated, real-time analysis.

In accordance with aspects of the present disclosure, a FEDS is configured to capture and analyze environmental data using a network of sensors and a deep learning model. A FEDS in accordance with aspects of the present disclosure can receive data from various sensors, including those for smoke, liquified petroleum gas (LPG), CO2, temperature, humidity, and sound, and transmitting this data to a server. Some embodiments may include a sound filtration system to eliminate any frequencies that are above 10 KHz and anything below 100 Hz. Additionally, in some embodiments additional sound frequencies associated with a power supply may be filtered to remove unnecessary noise.

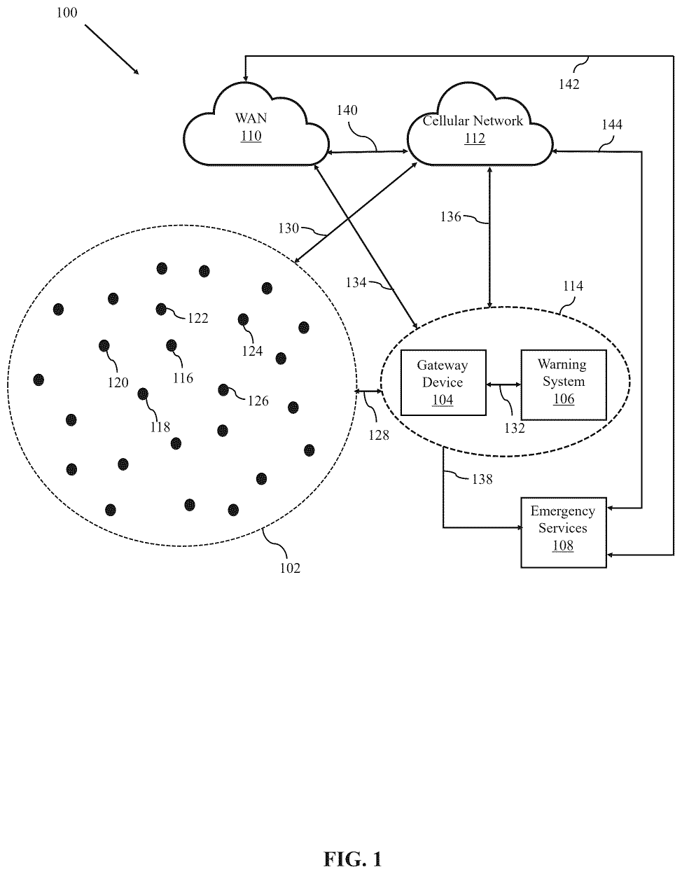

FIG. 1 illustrates an example FEDS 100 in accordance with aspects of the present disclosure.

As shown in the figure, FEDS 100 includes: a plurality of sensory nodes 102, a sample of which are indicated as sensory nodes 116, 118, 120, 122, 124, and 126; a gateway device 104; a warning system 106; emergency services 108; a wide area network (WAN) 110, and a cellular network 112.

Gateway device 104 and warning system 106 may be connected via a local area network (LAN) 114.

In some embodiments, plurality of sensory nodes 102 are configured to communicate with gateway device 104 via LAN 114 and a communication channel 128. In some embodiments, plurality of sensory nodes 102 are configured to communicate with gateway device 104 directly via communication channel 128. In some embodiments, plurality of sensory nodes 102 are configured to communicate with cellular network 112 via a communication channel 130.

In some embodiments, gateway device 104 is configured to communicate with warning system 106 via LAN 114. In some embodiments, gateway device 104 is configured to communicate directly with warning system 106 via a communication channel 132. In some embodiments, gateway device 104 is configured to communicate with emergency services 108 via LAN 114 and a communication channel 138. In some embodiments, gateway device 104 is configured to communicate with WAN 110 via LAN 114 and a communication channel 134. In some embodiments, gateway device 104 is configured to communicate with WAN 110 directly via communication channel 134. In some embodiments, gateway device 104 is configured to communicate with cellular network 112 via LAN 114 and a communication channel 136. In some embodiments, gateway device 104 is configured to communicate with cellular network 112 directly via communication channel 136.

In some embodiments, WAN 110 is additionally configured to communicate with cellular network 112 via a communication channel 140. In some embodiments, WAN 110 is additionally configured to communicate with emergency services 108 via a communication channel 142.

In some embodiments, cellular network 112 is additionally configured to communicate with emergency services 108 via a communication channel 144.

Each sensory node of plurality of sensory nodes 102 may be any device or system that is configured to detect a parameter of an environment surrounding the sensory node at its location and to output a parameter signal based on the detected parameter.

Gateway device 104 may be any device or system that is configured to connect disparate networks by translating communications from one protocol to another, and to wirelessly receive a detection signal from at least one sensory node of plurality of sensory nodes 102 via a first communication protocol and to communicate with warning system 106 via a network communication protocol.

Warning system 106 may be any device or system that is configured to receive a detection signal from gateway device 104 via the network communication protocol and to output a fire warning signal based on the detection signal.

Emergency services 108 may be any device or system that is configured to receive the fire warning signal from warning system 106 and to instruct predetermined emergency service providers, non-limiting examples of which include firefighters and rangers, of the existence and location of a fire.

WAN 110 may be any known system that is configured to connect networks over a large geographic area, such as across cities, countries, or even globally, a non-limiting example of which is the Internet.

Cellular network 112 may be any known type of telecommunications network where the area covered is divided into smaller geographical regions called cells, each served by at least one fixed-location transceiver known as a cell site or base station.

In operation, as will be described in greater detail below, warning system 106 includes a deep learning model that is pre-trained to identify data associated with a fire. Each sensory node in plurality of sensory nodes 102 includes at least one sensor that is configured to detect a parameter of the environment around its respective location.

A fire changes parameters of an environment, for example by producing heat, generating smoke, creating sound, etc. Each sensory node of plurality of sensory nodes 102 is configured to detect these changes in the parameters of the environment. A sensory node may then transmit a detection signal to gateway device 104.

Gateway device 104 then provides a detection signal to warning system 106, wherein warning system 106 evaluates the detection signal via the deep learning model to determine if the detection signal is associated with a fire.

If the deep learning model does determine that the detection signal is associated with a fire, then warning system 106 outputs a fire warning signal to gateway device 104. Upon receiving the fire warning signal, gateway device 104 transmits the fire warning signal to emergency services 108. Upon receiving the fire warning signal, emergency services 108 may deploy the predetermined emergency service providers to the location of the fire.

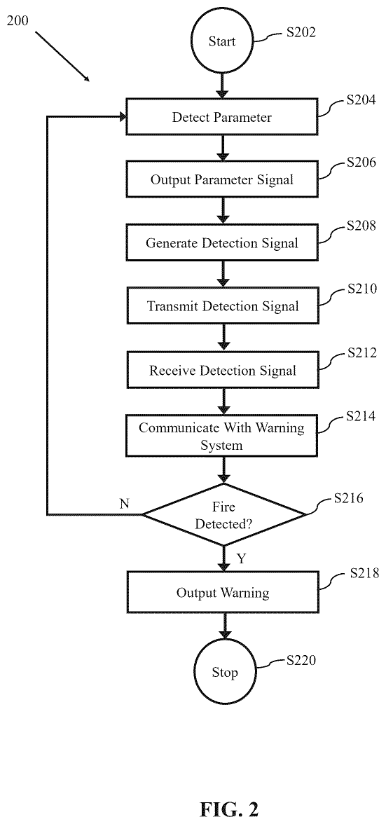

FIG. 2 illustrates an example method 200 of early detection of fires in accordance with aspects of the present disclosure.

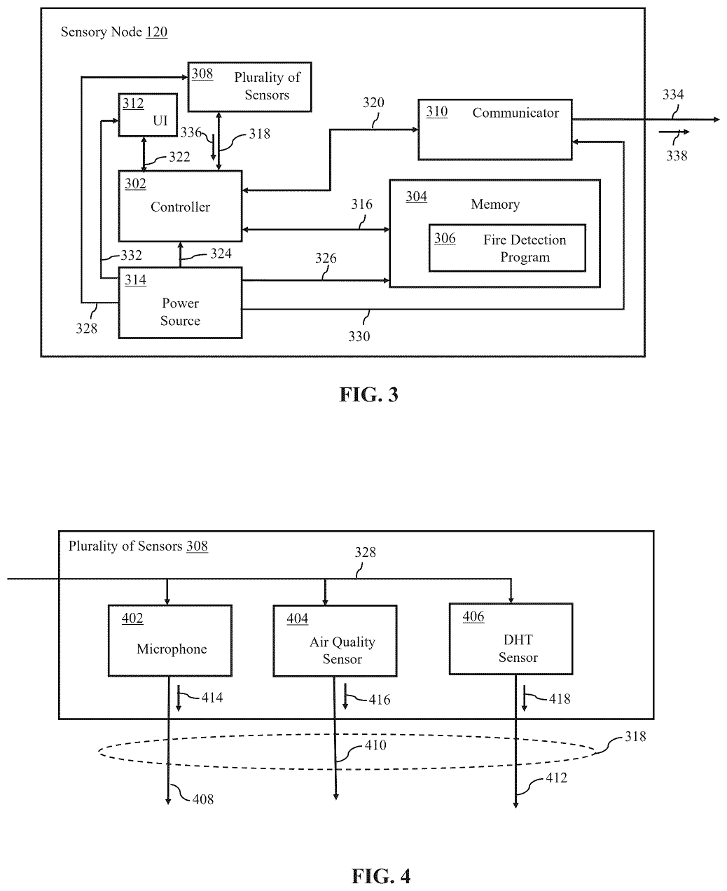

As shown in the figure, method 200 starts (S202), and a parameter is detected (S204). This will be described in greater detail with reference to FIG. 3.

FIG. 3 illustrates a black box diagram of an example sensory node 120 of FEDS 100.

As shown in the figure, sensory node 120 includes a controller 302, a memory 304 having a fire detection program 306 stored therein, a plurality of sensors 308, a communicator 310, a user interface (UI) 312, and a power source 314.

In this example, controller 302, memory 304, plurality of sensors 308, communicator 310, UI 312, and power source 314 are illustrated as individual devices. However, in some embodiments, at least two of controller 302, memory 304, plurality of sensors 308, communicator 310, UI 312, and power source 314 may be combined as a unitary device. Further, in some embodiments, at least one of controller 302 and UI 312, may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from, and write information to the tangible computer-readable media. In the alternative, the tangible computer-readable media may be integral to the processor. The processor and the tangible computer-readable media may reside in an application specific integrated circuit (“ASIC”). In the alternative, the processor and the tangible computer-readable media may reside as discrete components.

Example tangible computer-readable media may also be coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

A program/utility, having a set (at least one) of program modules, may be stored in the memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the application as described herein. In this example, fire detection program 306 is a program/utility.

Controller 302 is configured to: communicate with memory 304 via a communication channel 316; communicate with plurality of sensor 308 via a communication channel 318; communicate with communicator 310 via a communication channel 320; communicate with UI 312 via a communication channel 322; and receive power from power source 314 via a power line 324.

Each of communication channels 316, 318, 320, and 322 may be any known type of wired or wireless communication channel.

Controller 302 may be any device or system that is configured to control the operation of sensory node 120. Controller 302 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of sensory node 120 in accordance with the embodiments described in the present disclosure.

Memory 304 may be any device or system capable of storing data and instructions, including fire detection program 306.

In some embodiments, as will be described in greater detail below, fire detection program 306 has instructions stored therein to be executed by controller 302 to cause sensory node 120 to: detect a parameter of an environment surrounding sensory node 120 at its location; output a parameter signal based on the detected parameter; generate, based on the parameter signal, a detection signal; and wirelessly transmit the detection signal to gateway device 104.

In some embodiments, as will be described in greater detail below, fire detection program 306 has additional instructions stored therein to be executed by controller 302 to additionally cause sensory node 120 to: detect a second parameter of the environment surrounding sensory node 120 at the location; output a second parameter signal based on the detected second parameter; and generate, based on the parameter signal and the second parameter signal, the detection signal.

In some embodiments, as will be described in greater detail below, fire detection program 306 has additional instructions stored therein to be executed by controller 302 to additionally cause sensory node 120 to: wirelessly receive a second detection signal from another sensory node; and wirelessly the second detection signal.

Each sensor of plurality of sensors 308 may be any device or system that is configured to detect a respective parameter of an environment surrounding sensory node 120 at its location.

Plurality of sensors 308 may include at least one sensor that is configured to detect at least one parameter of a group of parameters comprising sound volume, sound frequency composition, temperature, pressure, humidity, gas composition, wind magnitude, wind direction, change in sound volume, change in sound frequency composition, change in temperature, change in pressure, change in humidity, change in gas composition, change in wind magnitude, change in wind direction, and combinations thereof.

Communicator 310 may be any device or system that is configured to wirelessly communicate with gateway device 104 over a communication channel 334. Communicator 310 may include a Wi-Fi WLAN interface radio transceiver that is operable to communicate with gateway device 104, for example as shown in FIG. 1, and also may include a cellular transceiver operable to communicate with cellular network 112. Communicator 310 may include one or more antennas and communicate wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, 6E, or 7 protocols. Communicator 310 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 6E GHz bands, RF4CE protocol, Z-Wave protocol, or IEEE 802.15.4 protocol. Communicator 310 can also be equipped with a radio transceiver/wireless communication circuit to implement a wireless connection in accordance with any Internet of Things (IOT) protocols, such as LoRa, such as the 902-928 MHz band, the 433 MHz and 868 MHz ISM bands, and the 915 MHz ISM band. Communicator 310 can also be equipped with a light transmitter/light receiver communication circuit to implement a wireless connection in accordance with LiFi communication protocols.

UI 312 may be any device or system that is configured to enable a user to interact with controller 302.

Power source 314 is additionally configured to: provide power to memory 304 via a power line 326; provide power to plurality of sensor 308 via a power line 328; provide power to communicator 310 via a power line 330; and provide power to UI 312 via a power line 332.

Each of power line 324, 326, 328, 330, and 332 may be any known type of power line.

Power source 314 may be any device or system that is configured to provide power without being connected to an established electrical grid. Power source 314 may be selected from at least one of a group of power sources including a battery, a capacitor, an energy harvesting system, a generator, and combinations thereof. Energy harvesting systems include solar generators, wind generators, thermoelectric generators, and hydroelectric generators.

In operation, sensory node 120 is placed a location within an area to be monitored, for example, as shown in FIG. 1. In some embodiments, the area to be monitored is a forest or portion of a forest, such that the fire to be detected is a forest fire. In some embodiments, the area to be monitored is at least a portion of the area within a building, such that the fire to be detected is a building fire. In some embodiments, the area to be monitored is at least a portion of the area within a ship, such that the fire to be detected is a ship fire.

Returning to FIG. 3, at least one sensor in plurality of sensors 308 is configured to detect a parameter of the environment surrounding sensory node 120 and to output a parameter signal 336 to controller 302 via communication channel 318. A non-limiting example of plurality of sensors 308 will now be described in greater detail with reference to FIG. 4.

FIG. 4 illustrates an example of plurality of sensors 308. As shown in the figure, plurality of sensors 308 includes a microphone 402, an air quality sensor 404, and a digital temperature and humidity (DHT) sensor 406.

In this example, microphone 402, air quality sensor 404 and DHT sensor 406 are illustrated as individual devices. However, in some embodiments, at least two of controller microphone 402, air quality sensor 404 and DHT sensor 406 may be combined as a unitary device.

Microphone 402 may be any device or system that is configured to detect sound and output a sound signal 414, based on the detected sound, to controller 302 via a communication channel 408.

Air quality sensor 404 may be any device or system that is configured to detect and measure various air pollutants and environmental conditions in the air and output an air quality signal 416, based on the detected various air pollutants and environmental conditions, to controller 302 via a communication channel 410. Air quality sensor 404 may use optical, electrical, thermal, or other methods to detect indicators of air pollution, such as gases and particulate matter. Air quality sensor 404 may measure air pollutants, including particulate matter (PM1, PM2.5, PM10), nitrogen dioxide (NO2), ozone (O3), sulfur dioxide (SO2), carbon monoxide (CO), and others.

DHT sensor 406 may be any device or system that is configured to detect humidity and temperature and to output a DHT signal 418, based on the detected humidity and temperature, to controller 302 via a communication channel 412.

Microphone 402, air quality sensor 404 and DHT sensor 406 are configured to receive power from power source 314 via power line 328. It should be noted that in some embodiments, each of microphone 402, air quality sensor 404 and DHT sensor 406 may have an individual respective power line for which it receive power from power source 314.

In this example, communication channel 408, communication channel 410, and communication channel 412 together correspond to communication channel 318 of FIG. 3.

In some embodiments, each of microphone 402, air quality sensor 404 and DHT sensor 406 are configured to continuously detect their respective parameters. In some of these embodiments: microphone 402 may be additionally configured to periodically output a sound signal 414 at a first predetermined periodicity; air quality sensor 404 may be additionally configured to periodically output air quality signal 416 at a second predetermined periodicity; and DHT sensor 406 may be further configured to periodically output a DHT signal 418 at a third predetermined periodicity. In some of these embodiments, the first predetermined periodicity, the second predetermined periodicity, and the third periodicity are the same periodicity, whereas in other embodiments, at least one of the first predetermined periodicity, the second predetermined periodicity, and the third periodicity is different from at least one other of the first predetermined periodicity, the second predetermined periodicity, and the third periodicity.

In some embodiments, at least one of microphone 402, air quality sensor 404 and DHT sensor 406 are configured to operate in either a sleep mode or a detecting mode. The sleep mode consumes less power than the detecting mode. In the sleep mode, no parameters are detected, whereas in the detecting mode, the parameters are detected. In some of these embodiments, the sleep mode lasts for a first predetermined period of time and the detecting mode lasts for a second predetermined period of time. In some embodiments, a period of time for which the sleep mode lasts and a period of time for which the detecting mode lasts may each be set by a user via UI 312.

By operating each sensor in a periodic sleep/detecting mode, less power is consumed than when all the sensors are continuously operating. However, if the sleep mode is too long, for example 2 hours, then a fire might go undetected for two hours.

In some embodiments, one of microphone 402, air quality sensor 404 and DHT sensor 406 is configured to operate to continuously detect its respective parameter, whereas the other two sensors are configured to operate in a sleep mode. If the sensor that is configured to continuously detect its respective parameter, and a value of the detected parameter meets a predetermined criteria that is associated with a fire, the sensor is additionally configured to output a wake up signal. The wake up signal causes the other two sensors that are operating in a sleep mode to switch to operating in a detecting mode.

By operating all but one sensor in a periodic sleep/detecting mode, less power is consumed than when all the sensors are continuously operating. However, embodiments wherein one sensor operates continuously will consume more power as compared to embodiments wherein all sensors are operating in a periodic sleep/detecting mode. However, the one continuously operating sensor may be able to more quickly identify a possible fire. Then the awakened sensors may detect additional parameters to verify the existence of a fire.

Returning to FIG. 2, after a parameter is detected (S204), a parameter signal is output (S206). For example, as shown in FIG. 3, plurality of sensors 318 outputs parameter signal 336 to controller 302 via communication channel 318.

In some embodiments, parameter signal 336 corresponds to a single signal from a single sensor. For example, as shown in FIG. 4, parameter signal 336 may correspond to one of sound signal 414, air quality signal 416, and DHT signal 418.

In some embodiments, parameter signal 336 corresponds to a signal from more than one sensor. For example, as shown in FIG. 4, parameter signal 336 may correspond to some combination of at least two of sound signal 414, air quality signal 416, and DHT signal 418. In some embodiments, the combination of at least two signals is derived from a serial transmission of the at least two signals, e.g., a first output of sound signal 414 followed by a second output of air quality signal 416. In some embodiments, the combination of at least two signals is derived from a multiplexed transmission of the at least two signals, e.g., a time division multiplex of sound signal 414 and air quality signal 416.

Returning to FIG. 2, after a parameter signal is output (S206), a detection signal is generated (S208). For example, as shown in FIG. 3, controller 302 generates a detection signal based on parameter signal 336.

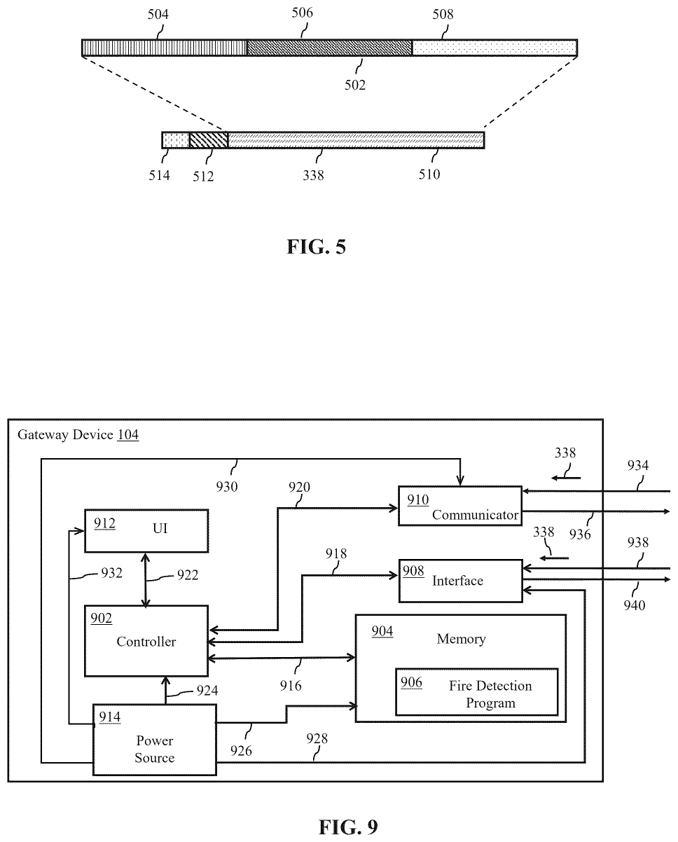

In operation, controller 302 is configured to execute instructions in fire detection program 306 to generate a detection signal based on parameter signal 336. Controller 302 may generate detection signal by gathering the data of the from parameter signal 336, adding location identification data, and then encoding the data into a format for transmission. This will be described in greater detail with reference to FIG. 5.

FIG. 5 illustrates data of parameter signal 336 and data of detection signal 338.

As shown in the figure, a data packet 502 corresponds to data of parameter signal 336. Data stream 502 includes a string of data bits 504 corresponding to sound signal 414, a string of data bits 506 corresponding to air quality signal 416, and a string of bits 508 corresponding to DHT signal 418.

Controller 302 is configured to execute instructions in fire detection program 306 to scrape string of data bits 504, string of data bits 506 and string of data bits 508 to create a payload string of bits 510.

In some embodiments, controller 302 is configured to execute the instructions in fire detection program 306 to filter sound signal 414 to eliminate any frequencies above 10 KHz and any frequencies below 100 Hz. In some of these embodiments, controller 302 is configured to execute the instructions in fire detection program 306 to further notch-filter sound signal 414 to eliminate predetermined frequencies or bands of frequencies. In some of these embodiments, controller 302 is configured to execute the instructions in fire detection program 306 to notch-filter sound signal 414 to eliminate any frequencies, or band of frequencies, corresponding to frequencies generated by other operating components within sensory node 102. In a non-limiting example embodiment, controller 302 is configured to execute the instructions in fire detection program 306 to further notch-filter 60 Hz from sound signal 414, which corresponds to the frequency generated by the operation of power source 314.

Controller 302 is further configured to execute instructions in fire detection program 306 to add identification data in a string of identification data bits 512. In some embodiments, the identification data includes global positioning system (GPS) coordinates corresponding to the location of sensory node 120. In some embodiments, the identification data includes a sensory node identification number corresponding to sensory node 120.

Controller 302 is further configured to execute instructions in fire detection program 306 to add header data in a string of header data bits 514. The header data corresponds to the communication protocol for which sensory node 120 will communicate with gateway device 104.

Returning to FIG. 2, after a detection signal is generated (S208), the detection signal is transmitted (S210). For example, as shown in FIG. 3, controller 302 is configured to execute instructions in fire detection program 306 to instruct communicator 310 to transmit detection signal 338 to gateway device 104 via communication channel 334.

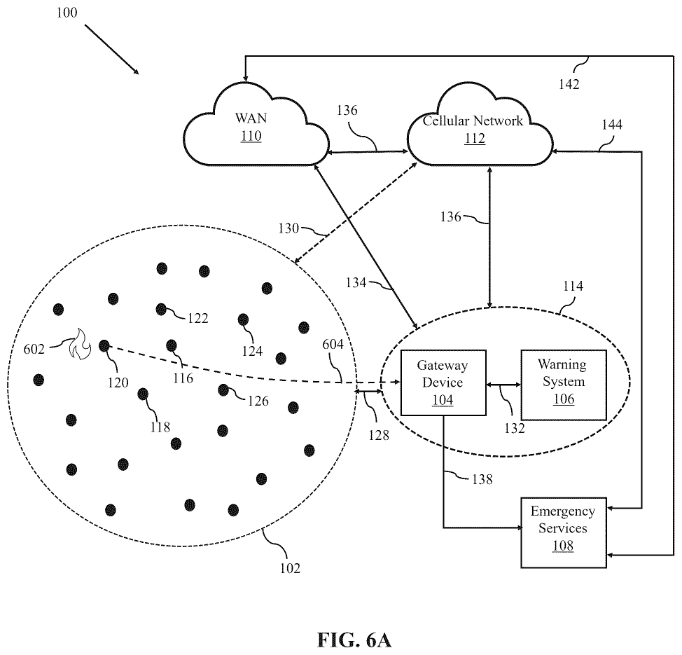

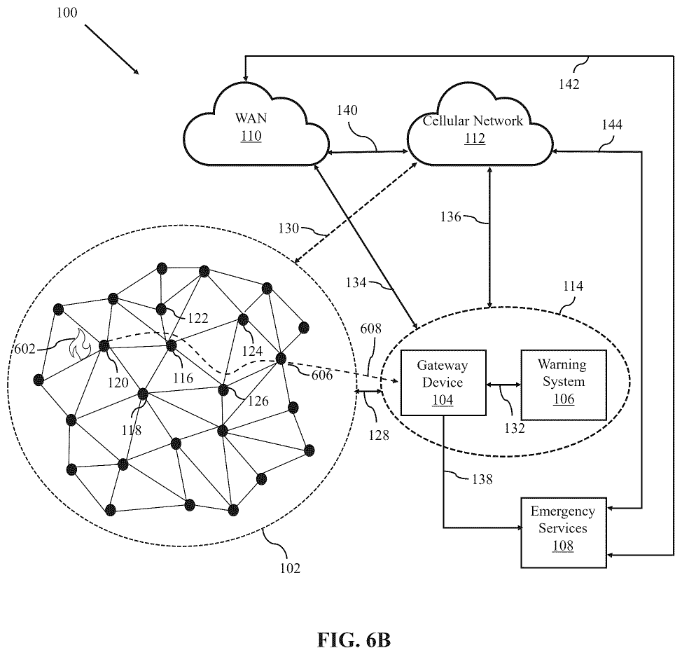

FIG. 6A illustrates an example of FEDS 100 in accordance with aspects of the present disclosure, wherein sensory node 120 detects a fire 602 and transmits detection signal 338 directly to gateway device 104. In these embodiments, sensory node 120 is in direct wireless communication with LAN 114 via wireless communication channel 128 as shown by dotted arrow 604. Returning to FIG. 3, in these embodiments, communication channel 334 corresponds to communication channel 128 of FIG. 6A. As such, communicator 310 must have sufficient power to transmit detection signal 338 through communication channel 334 over the distance between sensory node 120 and gateway device 104. As this distance will likely be extremely far, the power requirement will be very high. One way to address this power requirement is to hop the detection signal through a series of sensory nodes. This will be described in greater detail with reference to FIG. 6B.

FIG. 6B illustrates an example FEDS 100 in accordance with aspects of the present disclosure, wherein sensory node 120 detects fire 602 and transmits detection signal 338 to gateway device 104, via other sensory nodes. In these embodiments, plurality of sensory nodes 102 are configured in a mesh network, wherein each sensory node is configured to communicate with neighboring sensory nodes. Further, in this mesh network, only a sensory node 606, which is geographically closest to gateway device 104, is configured to transmit a detection signal directly to gateway device 104. In this manner, the distance from sensory node 606 to gateway device 104 is much smaller than the distance from sensory node 120 and gateway device 104. Therefore, the radio from sensory node 606 does not need as much power to transmit to gateway device 104.

In operation, sensory node 120 detects fire 602 and transmits detection signal 338 to neighboring sensory node 116, which transponds detection signal 338 to sensory node 126, which transponds detection signal 338 to sensory node 608, which then transponds detection signal 338 to gateway device 104 via communication channel 128, as shown by dotted arrow 608.

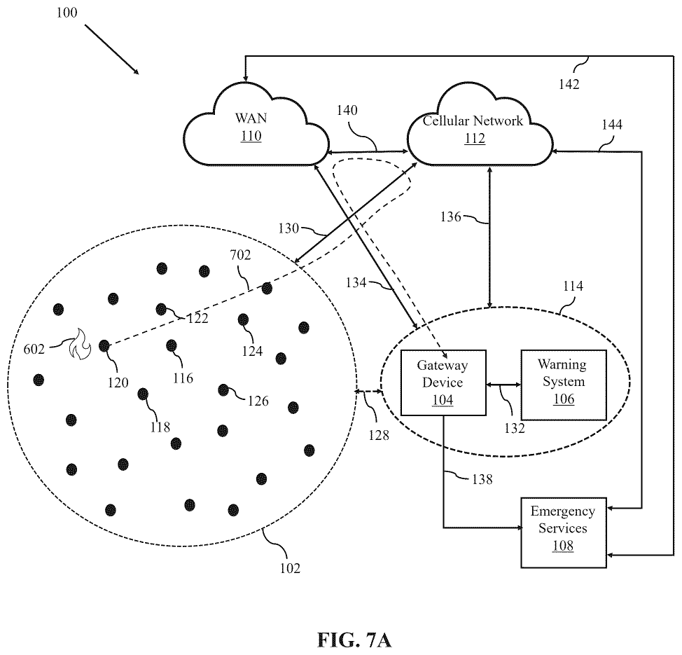

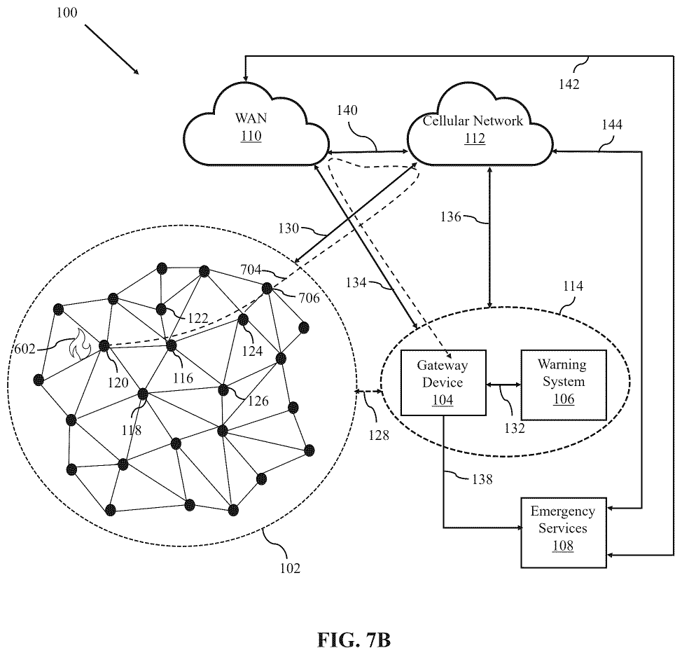

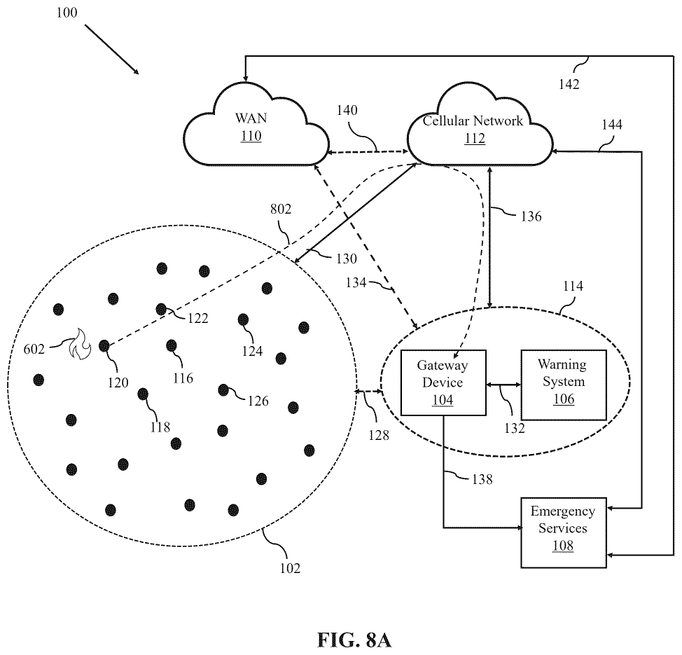

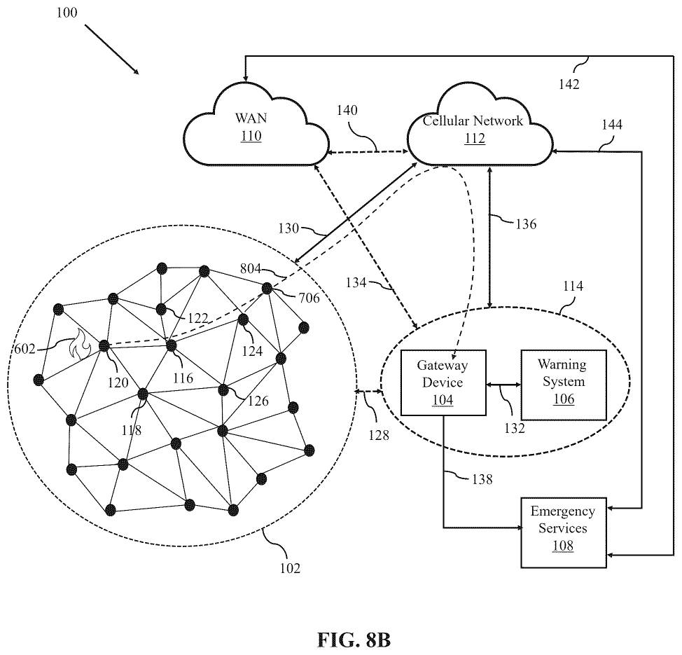

In some embodiments, a sensory node is configured to transmit a detection signal to gateway device 104 via cellular network 112, or a combination of cellular network 112 and WAN 110. These embodiments will now be described in greater detail with reference to FIGS. 7A-8B.

FIG. 7A illustrates an example of FEDS 100 in accordance with aspects of the present disclosure, wherein sensory node 120 detects fire 602 and transmits detection signal 338 to gateway device 104 via cellular network 112 and WAN 110. In these embodiments, sensory node 120 is in direct wireless communication with cellular network 112 via wireless communication channel 130, which is then routed through WAN 110 via wireless communication channel 140, and which is then routed to gateway device via communication channel 134, as shown by dotted arrow 702. Returning to FIG. 3, in these embodiments, communication channel 334 corresponds to communication channel 130. As such, communicator 310 must have sufficient power to transmit detection signal 338 through communication channel 334 to a nearby cellular tower (not shown). This distance may be extremely far, in which case the power requirement will be very high. One way to address this power requirement is to hop the detection signal through a series of sensory nodes. This will be described in greater detail with reference to FIG. 7B.

FIG. 7B illustrates an example of FEDS 100 in accordance with aspects of the present disclosure, wherein sensory node 120 detects fire 602 and transmits detection signal 338 to gateway device 104 via a mesh network of nodes, cellular network 112, and WAN 110.

In these embodiments, plurality of sensory nodes 102 are configured in a mesh network, wherein each sensory node is configured to communicate with neighboring sensory nodes in a manner similar to the discussed above with reference to FIG. 6B. For purposes of discussion, let a sensory node 706 be the closest sensory node of plurality of sensory nodes 102 to a cellular tower (not shown) for cellular network 112. In this manner, the distance from a sensory node 706 to the cellular tower is much smaller than the distance from sensory node 120 to the cellular tower. Therefore, the radio from sensory node 706 does not need as much power to transmit to the cellular tower.

In operation, sensory node 120 detects fire 602 and transmits detection signal 338 to neighboring sensory node 116, which transponds detection signal 338 to sensory node 124, which transponds detection signal 338 to sensory node 706, which then transponds detection signal 338 to the nearby cellular tower thus transmitting to cellular network 112 via communication channel 130, as shown by dotted arrow 704, which is then transmitted to WAN 110 via communication channel 140, which is then transmitted to gateway device 104 via communication channel 134.

FIG. 8A illustrates an example of FEDS 100 in accordance with aspects of the present disclosure, wherein sensory node 120 detects fire 602 and transmits detection signal 338 to gateway device 104 via cellular network 112. In these embodiments, sensory node 120 is in direct wireless communication with cellular network 112 via wireless communication channel 130, which is then routed to gateway device via communication channel 134, as shown by dotted arrow 802. Returning to FIG. 3, in these embodiments, communication channel 334 corresponds to communication channel 130. As such, communicator 310 must have sufficient power to transmit detection signal 338 through communication channel 334 to a nearby cellular tower (not shown). This distance may be extremely far, in which case the power requirement will be very high. One way to address this power requirement is to hop the detection signal through a series of sensory nodes. This will be described in greater detail with reference to FIG. 8B.

FIG. 8B illustrates an example of FEDS 100 in accordance with aspects of the present disclosure, wherein sensory node 120 detects fire 602 and transmits detection signal 338 to gateway device 104 via a mesh network of nodes, and cellular network 112.

In these embodiments, plurality of sensory nodes 102 are configured in a mesh network, wherein each sensory node is configured to communicate with neighboring sensory nodes in a manner similar to the discussed above with reference to FIG. 7B. For purposes of discussion, let a sensory node 706 be the closest sensory node of plurality of sensory nodes 102 to a cellular tower (not shown) for cellular network 112. In this manner, the distance from a sensory node 706 to the cellular tower is much smaller than the distance from sensory node 120 to the cellular tower. Therefore, the radio from sensory node 706 does not need as much power to transmit to the cellular tower.

In operation, sensory node 120 detects fire 602 and transmits detection signal 338 to neighboring sensory node 116, which transponds detection signal 338 to sensory node 124, which transponds detection signal 338 to sensory node 706, which then transponds detection signal 338 to the nearby cellular tower thus transmitting to cellular network 112 via communication channel 130, as shown by dotted arrow 804, which is then transmitted to gateway device 104 via communication channel 136.

Returning to FIG. 2, after the detection signal is transmitted (S210), the detection signal is received (S212). For example, as shown in FIG. 1, gateway device 104 receives a detection signal from one of the sensory nodes. This will be described in greater detail with reference to FIG. 9.

FIG. 9 illustrates a black box diagram of an example of gateway device 104 of FEDS 100 of FIG. 1.

As shown in FIG. 9, gateway device 104 includes a controller 902, a memory 904 having a fire detection program 906 stored therein, an interface 908, a communicator 910, a user interface (UI) 912, and a power source 914.

In this example, controller 902, memory 904, interface 908, communicator 910, UI 912, and power source 914 are illustrated as individual devices. However, in some embodiments, at least two of controller 902, memory 904, interface 908, communicator 910, UI 912, and power source 914 may be combined as a unitary device. Further, in some embodiments, at least one of controller 902, interface 908, and UI 912, may be implemented as a computer having tangible computer-readable media for carrying or having computer-executable instructions or data structures stored thereon.

Controller 902 is configured to: communicate with memory 904 via a communication channel 916; communicate with interface 908 via a communication channel 918; communicate with communicator 910 via a communication channel 920; communicate with UI 912 via a communication channel 922; and receive power from power source 914 via a power line 924.

Each of communication channels 916, 918, 920, and 922 may be any known type of wired or wireless communication channel.

Controller 902 may be any device or system that is configured to control operations of gateway device 104. Controller 902 may be implemented as a hardware processor such as a microprocessor, a multi-core processor, a single core processor, an FPGA, a microcontroller, an ASIC, a DSP, or other similar processing device capable of executing any type of instructions, algorithms, or software for controlling the operation and functions of gateway device 104 in accordance with the embodiments described in the present disclosure

Memory 904 may be any device or system capable of storing data and instructions, including fire detection program 906.

In some embodiments, as will be described in greater detail below, fire detection program 906 has instructions stored therein to be executed by controller 902 to cause gateway device 104 to: receive the detection signal from sensory node 120; and transmit the detection signal to warning system 106.

In some embodiments, as will be described in greater detail below, fire detection program 906 has additional instructions stored therein to be executed by controller 902 to additionally cause gateway device 104 to: receive a warning signal from warning system 106; and transmit the warning signal to emergency services 108.

Interface 908 may be any device or system that is configured to enable gateway device 104 to communicate via predetermined communication protocols with an input communication channel 938 and an output communication channel 940. Interface 908 can include one or more connectors, such as RF connectors, or Ethernet connectors, and/or wireless communication circuitry, such as 5G circuitry and one or more antennas.

Communicator 910 may be any device or system that is configured to wirelessly communicate with sensory node 120 via an input communication channel 934.

In some embodiments, communicator 910 may be any device or system that is configured to additionally wirelessly communicate with warning system 106 via an output communication channel 936.

In some embodiments, communicator 910 may be any device or system that is configured to additionally wirelessly communicate with emergency services 108 via output communication channel 936.

Communicator 910 may include a Wi-Fi WLAN interface radio transceiver that is operable to communicate with a sensory node, with warning system 106 and with emergency services 108, for example as shown in FIG. 1, and also may include a cellular transceiver operable to communicate with cellular network 112. Communicator 910 may include one or more antennas and communicate wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, 6E, or 9 protocols. Communicator 910 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 6E GHz bands, RF4CE protocol, ZigBee protocol, Z-Wave protocol, or IEEE 802.15.4 protocol. Communicator 910 can also be equipped with a radio transceiver/wireless communication circuit to implement a wireless connection in accordance with any Internet of Things (IOT) protocols, such as LoRa, such as the 902-928 MHz band, the 433 MHz and 868 MHz ISM bands, and the 915 MHz ISM band. Communicator 910 can also be equipped with a light transmitter/light receiver communication circuit to implement a wireless connection in accordance with LiFi communication protocols.

UI 912 may be any device or system that is configured to enable a user to interact with controller 902.

Power source 914 is additionally configured to: provide power to memory 904 via a power line 926; provide power to interface 908 via a power line 928; provide power to communicator 910 via a power line 930; and provide power to UI 912 via a power line 932.

Each of power lines 924, 926, 928, 930, and 932 may be any known type of power line.

Power source 914 may be any device or system that is configured to provide power to gateway device.

In operation, in embodiments where gateway device 104 receives detection signal 338 from sensory node 120 via communication channel 128, for example as discussed above with reference to FIGS. 6A, 6B, input communication channel 934 corresponds to communication channel 128. Similarly, in embodiments where gateway device 104 receives detection signal 338 from sensory node 120 via communication channel 136, for example as discussed above with reference to FIGS. 8A and 8B, input communication channel 934 corresponds to communication channel 136. In any of these example embodiments, communicator 910 receives detection signal 338 via input communication channel 934.

In embodiments wherein gateway device 104 receives detection signal 338 from sensory node 120 via communication channel 134, for example as discussed above with reference to FIGS. 7A, 7B, input communication channel 938 corresponds to communication channel 134. In these example embodiments, interface 908 receives detection signal 338 via input communication channel 938.

Upon receiving detection signal 338, either via communicator 910 or interface 908, detection signal 338 is transmitted to controller 902 via communication channel 920 or communication channel 918, respectively.

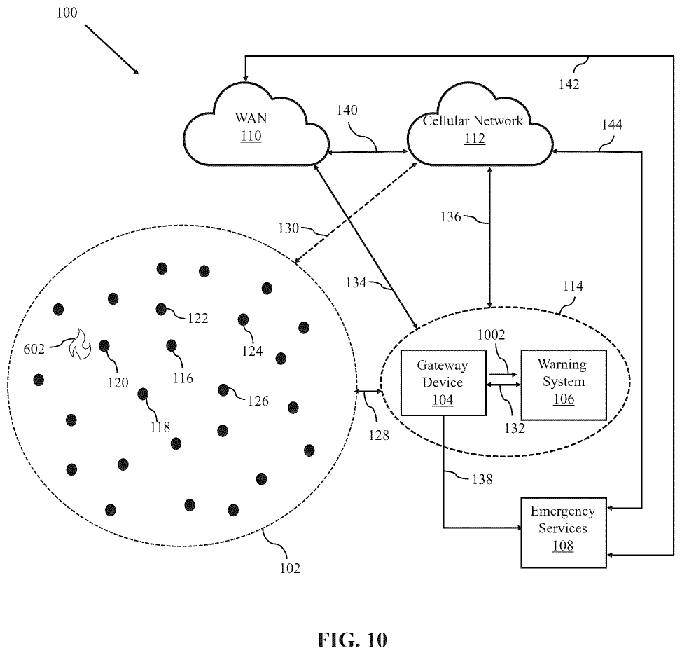

Returning to FIG. 2, after the detection signal is received (S212), gateway device 104 communicates with warning system 106 (S214). This will be described in greater detail with reference to FIG. 10.

FIG. 10 illustrates example FEDS 100 in accordance with aspects of the present disclosure, wherein gateway device 104 transmits a detection signal 1002 to warning system 106.

In some embodiments, detection signal 1002 is detection signal 338. However, in some embodiments, detection signal 1002 may be a modified version of detection signal 338. This will be described in greater detail with reference to FIG. 9.

As shown in the figure, gateway device 104 may communicate with a sensory node by one type of wireless, or wired communication protocol, as determined by the communication channel for which detection signal 338 is received. Further, gateway device 104 may communicate with warning system 106 via another different communication protocol. As such, controller 902 may be configured to execute instructions in fire detection program 906 to modify detection signal 338 from one communication protocol to another communication protocol that is different, to thereby generate detection signal 1002.

Controller 902 may be additionally configured to execute instructions in fire detection program 906 to then transmit detection signal 1002 to warning system 106. In some embodiments, controller 902 may execute instructions in fire detection program 906 to cause communicator 910 to transmit detection signal 1002 via output communication channel 936. In some embodiments, controller 902 may execute instructions in fire detection program 906 to cause interface 908 to transmit detection signal 102 via output communication channel 940.

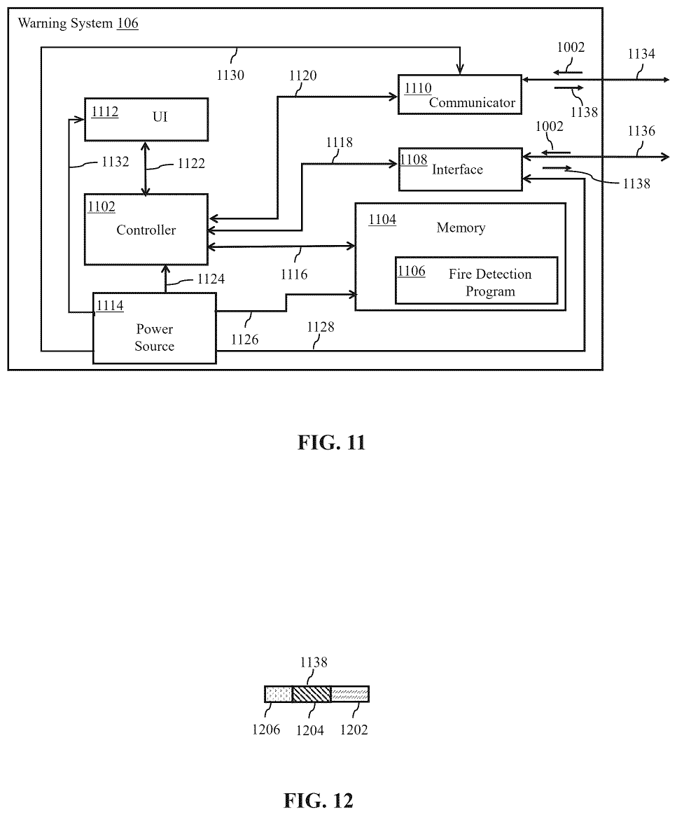

FIG. 11 illustrates a black box diagram of an example of warning system 106 of FEDS 100 of FIG. 1.

As shown in FIG. 11, warning system 106 includes a controller 1102, a memory 1104 having a fire detection program 1106 stored therein, an interface 1108, a communicator 1110, a user interface (UI) 1112, and a power source 1114.

In this example, controller 1102, memory 1104, interface 1108, communicator 1110, UI 1112, and power source 1114 are illustrated as individual devices. However, in some embodiments, at least two of controller 1102, memory 1104, interface 1108, communicator 1110, UI 1112, and power source 1114 may be combined as a unitary device. Further, in some embodiments, at least one of controller 1102, interface 1108, and UI 1112, may be implemented as a computer having tangible computer-readable media for carrying or having computer-executable instructions or data structures stored thereon.

Controller 1102 is configured to: communicate with memory 1104 via a communication channel 1116; communicate with interface 1108 via a communication channel 1118; communicate with communicator 1110 via a communication channel 1120; communicate with UI 1112 via a communication channel 1122; and receive power from power source 1114 via a power line 1124.

Each of communication channels 1116, 1118, 1120, and 1122 may be any known type of wired or wireless communication channel.

Controller 1102 may be any device or system that is configured to control operations of warning system 106. Controller 1102 may be implemented as a hardware processor such as a microprocessor, a multi-core processor, a single core processor, an FPGA, a microcontroller, an ASIC, a DSP, or other similar processing device capable of executing any type of instructions, algorithms, or software for controlling the operation and functions of warning system 106 in accordance with the embodiments described in the present disclosure.

Memory 1104 may be any device or system capable of storing data and instructions, including fire detection program 1106.

In some embodiments, as will be described in greater detail below, fire detection program 1106 has instructions stored therein to be executed by controller 1102 to cause warning system 106 to: receive the detection signal from gateway device 104; determine, based on the detection signal, whether a wild fire is detected; generate a warning signal if a wild fire is detected; and transmit the warning signal to gateway device 104.

Interface 1108 may be any device or system that is configured to enable warning system 106 to communicate via predetermined communication protocols with an input communication channel 1138 and an output communication channel 1140. Interface 1108 can include one or more connectors, such as RF connectors, or Ethernet connectors, and/or wireless communication circuitry, such as 5G circuitry and one or more antennas.

Communicator 1110 may be any device or system that is configured to wirelessly communicate with gateway device 104 via a communication channel 1134. Communicator 1110 may include a Wi-Fi WLAN interface radio transceiver that is operable to communicate with gateway device 104, for example as shown in FIG. 1, and also may include a cellular transceiver operable to communicate with cellular network 112. Communicator 1110 include one or more antennas and communicate wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, 6E, or 7 protocols. Communicator 1110 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 6E GHz bands, RF4CE protocol, ZigBee protocol, Z-Wave protocol, or IEEE 802.15.4 protocol. Communicator 1110 can also be equipped with a radio transceiver/wireless communication circuit to implement a wireless connection in accordance with any Internet of Things (IOT) protocols, such as LoRa, such as the 902-928 MHz band, the 433 MHz and 868 MHz ISM bands, and the 915 MHz ISM band. Communicator 1110 can also be equipped with a light transmitter/light receiver communication circuit to implement a wireless connection in accordance with LiFi communication protocols.

UI 1112 may be any device or system that is configured to enable a user to interact with controller 1102.

Power source 1114 is additionally configured to: provide power to memory 1104 via a power line 1126; provide power to interface 1108 via a power line 1128; provide power to communicator 1110 via a power line 1130; and provide power to UI 1112 via a power line 1132.

Each of power lines 1124, 1126, 1128, 1130, and 1132 may be any known type of power line.

In operation, warning system 106 receives detection signal 1002 from gateway device 104. In embodiments where warning system 106 receives detection signal 1002 from gateway device via communication channel 132, wherein communication channel 132 is a wireless communication channel, then communication channel 132 corresponds to communication channel 1134. In these example embodiments, communicator 1110 receives detection signal 1002 via communication channel 1134, and which corresponds to the combination of input communication channel 934 and output communication channel 936 of FIG. 9.

Alternatively, in embodiments where warning system 106 receives detection signal 1002 from gateway device 104 via communication channel 132, wherein communication channel 132 is a wired communication channel, then communication channel 1136 corresponds to communication channel 132. In these example embodiments, interface 1108 receives detection signal 1002 via communication channel 1136, and which corresponds to the combination of input communication channel 938 and output communication channel 940 of FIG. 9.

Upon receiving detection signal 1002, either via communicator 1110 or interface 1108, detection signal 1002 is transmitted to controller 1102 via communication channel 1120 or communication channel 1118, respectively.

Returning to FIG. 2, after gateway device 104 communicates with warning system 106 (S214), it is determined whether a fire is detected (S216). For example, as shown in FIG. 11, controller 1102 determines whether a fire is detected.

In some embodiments, controller 1102 is configured to execute instructions in fire detection program 1106 to decode the encoded detection signal 1002 in accordance with the communication protocol for which detection signal 1002 was received. For example, in embodiments, wherein detection signal 1002 was received via communicator 1110, controller 1102 is configured to execute instructions in fire detection program 1106 to decode the encoded detection signal 1002 in accordance with the wireless communication protocol for which it was received. Alternatively, in embodiments, wherein detection signal 1002 was received via interface 1108, controller 1102 is configured to execute instructions in fire detection program 1106 to decode the encoded detection signal 1002 in accordance with the wired communication protocol for which it was received.

In some embodiments, controller 1102 is configured to execute instructions in fire detection program 1106 to decode detection signal 1002 to parse out the data of parameter signal 510 and identification data in string of identification data bits 512. Controller 1102 is configured to execute instructions in fire detection program 1106 to store the identification data in string of identification data bits 512 in memory 1104.

In embodiments wherein the identification data in string of identification data bits 512 corresponds to GPS coordinates corresponding to the location of sensory node 120, controller 1102 is configured to execute instructions in fire detection program 1106 to store the GPS coordinates corresponding to the location of sensory node 120 into memory 1104.

In embodiments wherein the identification data in string of identification data bits 512 includes a sensory node identification number corresponding to sensory node 120, memory 1104 may have a data structure, e.g., a look-up-table, associating the sensory node identification number corresponding to sensory node 120 to a GPS coordinate of the location of sensory node 120.

Controller 1102 is configured to execute instructions in fire detection program 1106 to determine whether a fire is detected by inputting the data of detection signal 1002 into a deep learning model. More specifically, fire detection program 1106 includes a pre-trained deep learning model for identifying a fire.

In some embodiments, the deep learning model in fire detection program 1106 is pre-trained on data corresponding to data that is similar to data that will be collected by sensory nodes. For example, returning to FIG. 5, as mentioned previously, a data packet 502 corresponds to data of parameter signal 336. Data stream 502 includes a string of data bits 504 corresponding to sound signal 414, a string of data bits 506 corresponding to air quality signal 416, and a string of bits 508 corresponding to DHT signal 418. With this in mind, in an example embodiment, the deep learning model in fire detection program 1106 is pre-trained on multiple data sets corresponding sound data from multiple actual fires, multiple air quality data sets from multiple actual fires, and multiple DHT data sets from multiple actual fires.

In some embodiments, the deep learning model in fire detection program 1106 is pre-trained on multiple data sets corresponding sound data from multiple actual forest fires, multiple air quality data sets from multiple actual forest fires, and multiple DHT data sets from multiple actual forest fires. In some embodiments, the deep learning model in fire detection program 1106 is pre-trained on multiple data sets corresponding sound data from multiple actual building fires, multiple air quality data sets from multiple actual building fires, and multiple DHT data sets from multiple actual building fires. In some embodiments, the deep learning model in fire detection program 1106 is pre-trained on multiple data sets corresponding sound data from multiple actual ship fires, multiple air quality data sets from multiple actual ship fires, and multiple DHT data sets from multiple actual ship fires. In some embodiments, the deep learning model in fire detection program 1106 is pre-trained on multiple data sets corresponding sound data from: at least one of multiple actual forest fires, multiple actual building fires, and multiple actual ship fires; multiple air quality data sets from multiple actual forest fires, multiple actual building fires, and multiple actual ship fires; and multiple DHT data sets from multiple actual forest fires, multiple actual building fires, and multiple actual ship fires.

In accordance with neural network programming, the multiple weights and biases for the neural network are fined tuned via back-propagation to arrive at a pre-trained deep learning model, which is included in fire detection program 1106. Therefore, when the data from detection signal 1002 is inputted into the deep learning model, controller 1102 is able to determine whether the detection signal 1002 corresponds to a fire.

Returning to FIG. 2, if it is determined that a fire is not detected (N at S216), then the parameter is gain detected (return to S204) and method 200 continues. Alternatively, if it is determined that a fire is detected (Y at S216), then a warning is outputted (S218). For example, as shown in FIG. 11, controller 1102 generates a warning signal and instructs one of communicator 1110 and interface 1108 to output the warning signal.

In some embodiments, controller 1102 is configured to execute instructions in fire detection program 1106 to generate a warning signal 1138 when it is determined that a fire is detected.

In embodiments wherein the identification data in string of identification data bits 512 corresponds to GPS coordinates corresponding to the location of sensory node 120, and the GPS coordinates corresponding to the location of sensory node 120 have been stored into memory 1104, controller 1102 is configured to execute instructions in fire detection program 1106 to extract the GPS coordinates from memory 1104.

In embodiments wherein the identification data in string of identification data bits 512 includes a sensory node identification number corresponding to sensory node 120, and memory 1104 has a data structure, e.g., a look-up-table, associating the sensory node identification number corresponding to sensory node 120 to a GPS coordinate of the location of sensory node 120, controller 1102 is configured to execute instructions in fire detection program 1106 to extract the GPS coordinates from memory 1104.

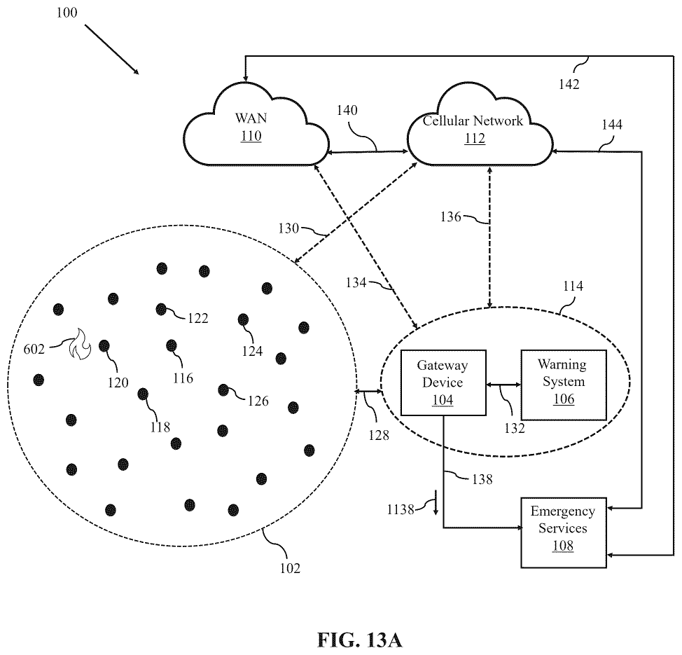

Controller 1102 is additionally configured to execute instructions in fire detection program 1106 to generate a warning signal 1138. This will be discussed in greater detail with reference to FIG. 12.

FIG. 12 illustrates data of warning signal 1138.

Controller 1102 is configured to execute instructions in fire detection program 1106 to create a payload bit 1202 indicating that a fire is detected.

Controller 1102 is further configured to execute instructions in fire detection program 1106 to extract the GPS coordinates from memory 1104 and add the GPS coordinates as location data bits 1204.

Controller 1102 is further configured to execute instructions in fire detection program 1106 to add header data in a string of header data bits 1206. The header data corresponds to the communication protocol for which gateway device 104 will communicate with emergency services 108.

Returning to FIG. 11, once generated, controller 1102 is further configured to execute instructions in fire detection program 1106 to cause warning system 106 to transmit warning signal 1138 to emergency services 108.

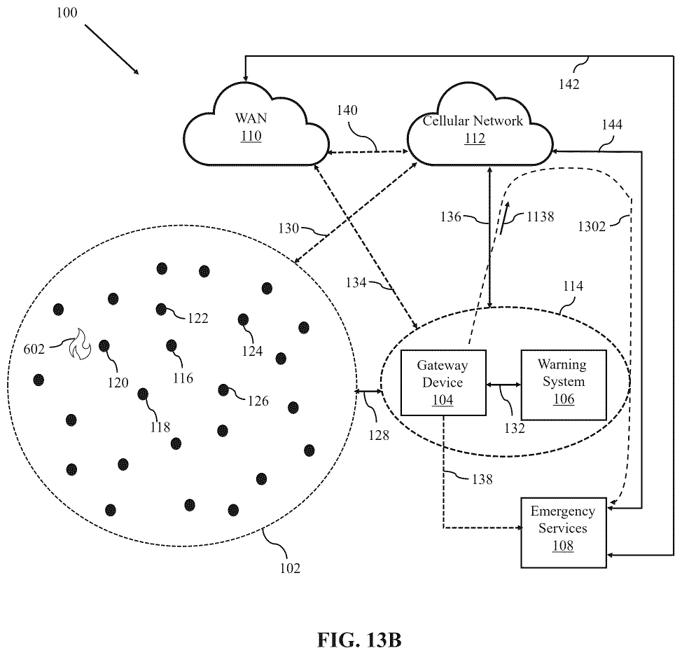

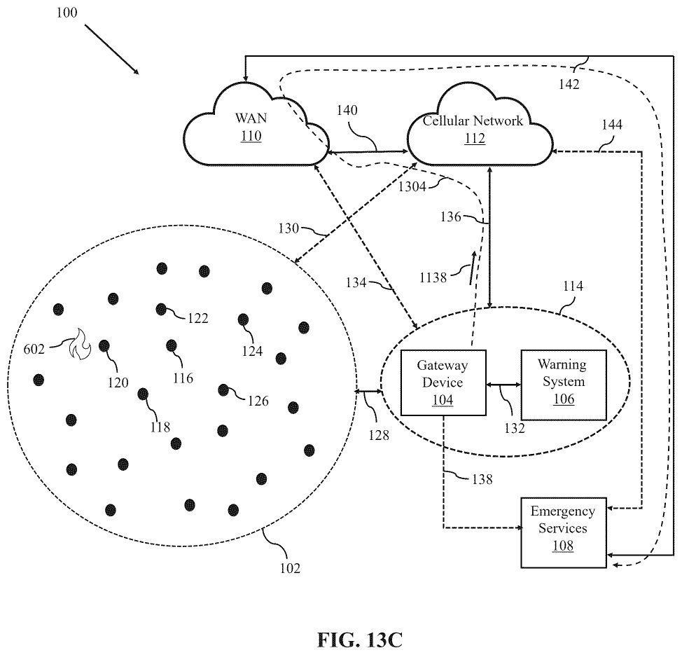

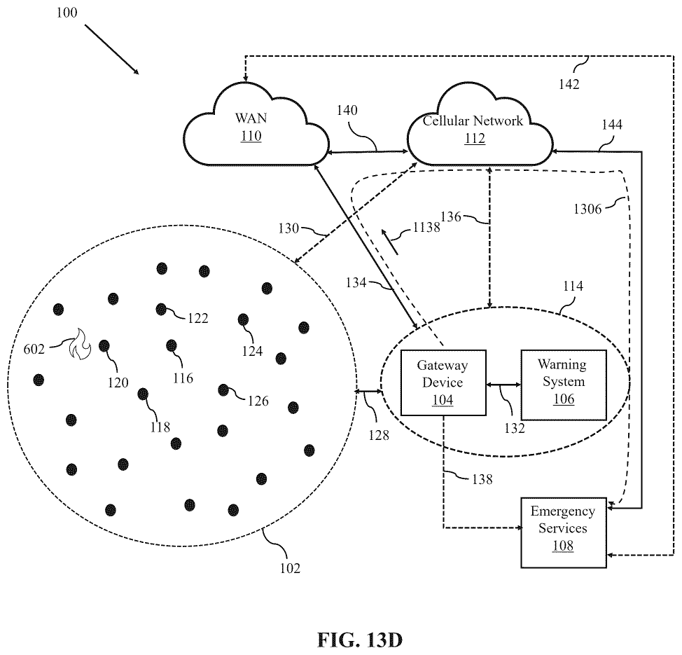

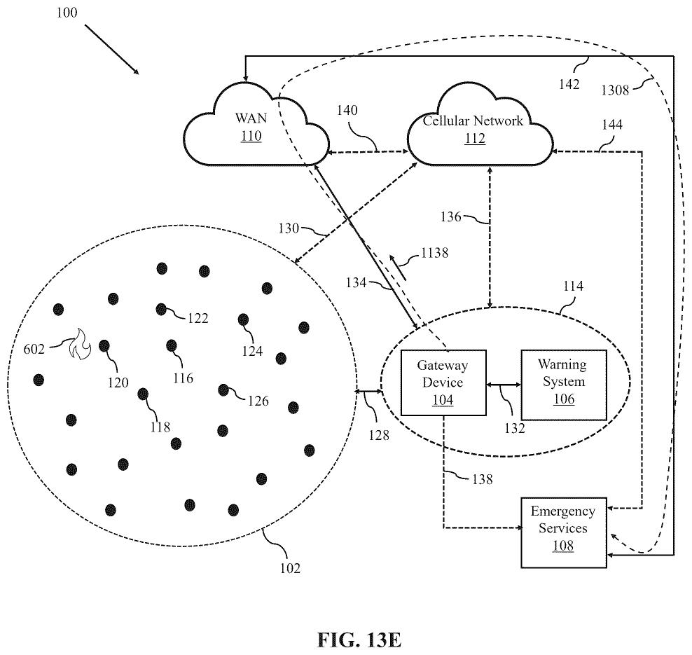

In some embodiments, gateway device 104 transmits warning signal 1138 directly to emergency services 1108 via communication channel 138. This is illustrated in FIG. 13A.

In some of these embodiments, wherein communication channel 138 is a wired communication channel, as shown in FIG. 11, communication channel 138 corresponds to communication channel 1136. In these embodiments, controller 1102 is configured to execute instructions in fire detection program 1106 to cause interface 1108 to transmit warning signal 1138 to emergency services 108 via communication channel 1136. In other of these embodiments, wherein communication channel 138 is a wireless communication channel, as shown in FIG. 11, communication channel 138 corresponds to communication channel 1134. In these embodiments, controller 1102 is configured to execute instructions in fire detection program 1106 to cause communicator 1110 to transmit warning signal 1138 to emergency services 108 via communication channel 1134.

Upon receiving warning signal 1138, either from communicator 1110 or interface 1108, detection signal 1002 is transmitted to controller 1102 via communication channel 1120 or communication channel 1118, respectively.

In some embodiments, gateway device 104 transmits warning signal 1138 to emergency services 1108 via cellular network 112. This is illustrated in FIG. 13B.

As shown in the figure, gateway device 1104 is configured to transmit warning signal 1138 to emergency services 108 via communication channel 136, cellular network 112, and communication channel 114.

As shown in FIG. 11, controller 1102 is configured to execute instructions in fire detection program 1106 to cause communicator 1110 to transmit warning signal 1138 to emergency services 108 via communication channel 136, cellular network 112, and communication channel 114.

In some embodiments, gateway device 104 transmits warning signal 1138 to emergency services 1108 via cellular network 112 and WAN 110. This is illustrated in FIG. 13C.

As shown in the figure, gateway device 1104 is configured to transmit warning signal 1138 to emergency services 108 via communication channel 136, cellular network 112, communication channel 140, WAN 110, and communication channel 142.

As shown in FIG. 11, controller 1102 is configured to execute instructions in fire detection program 1106 to cause communicator 1110 to transmit warning signal 1138 to emergency services 108 via communication channel 136, cellular network 112, communication channel 140, WAN 110, and communication channel 142.

In some embodiments, gateway device 104 transmits warning signal 1138 to emergency services 1108 via WAN 110 and cellular network 112. This is illustrated in FIG. 13D.

As shown in the figure, gateway device 1104 is configured to transmit warning signal 1138 to emergency services 108 via communication channel 134, WAN 110, communication channel 140, cellular network 112, and communication channel 144.

As shown in FIG. 11, controller 1102 is configured to execute instructions in fire detection program 1106 to cause interface 1108 to transmit warning signal 1138 to emergency services 108 via communication channel 134, WAN 110, communication channel 140, cellular network 112, and communication channel 144.

In some embodiments, gateway device 104 transmits warning signal 1138 to emergency services 1108 via WAN 110. This is illustrated in FIG. 13E.

As shown in the figure, gateway device 1104 is configured to transmit warning signal 1138 to emergency services 108 via communication channel 134, WAN 110, and communication channel 142.

As shown in FIG. 11, controller 1102 is configured to execute instructions in fire detection program 1106 to cause interface 1108 to transmit warning signal 1138 to emergency services 108 via communication channel 134, WAN 110, and communication channel 142.

Returning to FIG. 2, after a warning is outputted (S218), method 200 stops (S220).

In accordance with aspects of the present disclosure a fire early detection system and method mitigates reliance on human operators, potential for false alarms, and lack of automated, real-time analysis. A plurality of sensory nodes are placed throughout an area to be monitored for fires. Each sensory node include a power source, so that it need not be connected to an existing electrical grid. Further, each sensory node is configured to detect parameters associated with fires. A warning system is configured to analyze parameter data that is detected by the plurality of sensory nodes. The warning system includes a pre-trained deep learning model to identify fires based on the detected parameters from the sensory nodes. In this manner, fires may be detected early without reliance on human operators, by decreasing false alarms, and with automated, real-time analysis.

The foregoing description of various embodiments has been presented for purposes of illustration and description. It is not intended to be exhaustive or to limit the disclosure to the precise forms disclosed, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

What is claimed as new and desired to be protected by Letters Patent of the united States is:

1. A fire early detection system for use with a gateway device, the gateway device being configured to wirelessly receive a detection signal via a first communication protocol and to communicate via a network communication protocol, said fire early detection system comprising:
a sensory node configured to be disposed at a location; and
a warning system configured to receive the detection signal from the gateway device via the network communication protocol and to output a fire warning signal based on the detection signal,
wherein said sensory node comprises:
a sensor configured to detect a parameter of an environment surrounding said sensory node at the location and to output a parameter signal based on the detected parameter;
a communicator configured to wirelessly transmit the detection signal; a memory having instructions stored therein;
a processor configured to execute the instructions stored in said memory to:
generate, based on the parameter signal, the detection signal; and
cause said communicator to wirelessly transmit the detection signal; and
a power source configured to supply power to said sensor, said communicator, said memory and said processor.

2. The fire early detection system of claim 1, wherein said sensor is configured to detect the parameter as one of a group of parameters comprising sound volume, sound frequency composition, temperature, pressure, humidity, gas composition, wind magnitude, wind direction, change in sound volume, change in sound frequency composition, change in temperature, change in pressure, change in humidity, change in gas composition, change in wind magnitude, change in wind direction, and combinations thereof.

3. The fire early detection system of claim 1, wherein said sensory node further comprises:
a second sensor configured to detect a second parameter of the environment surrounding said sensory node at the location and to output a second parameter signal based on the detected second parameter,
wherein said processor is further configured to execute the instructions stored in said memory to generate, based on the parameter signal and the second parameter signal, the detection signal,
wherein said power source is further configured to supply power to said second sensor,
wherein said sensor is configured to detect the parameter as one of a group of parameters comprising sound volume, sound frequency composition, temperature, pressure, humidity, gas composition, wind magnitude, wind direction, change in sound volume, change in sound frequency composition, change in temperature, change in pressure, change in humidity, change in gas composition, change in wind magnitude, change in wind direction, and combinations thereof, and
wherein said second sensor is configured to detect the second parameter as another one of the group of parameters.

4. The fire early detection system of claim 1, wherein the gateway device is additionally configured to wirelessly receive a second detection signal via the first communication protocol, wherein the warning system being additionally configured to output a second fire warning signal based on the second detection signal, said fire early detection system further comprising:
a second sensory node configured to be disposed at a second location, said second sensory node comprising:
a second sensor configured to detect a second parameter of an environment surrounding said second sensory node at the second location and to output a second parameter signal based on the detected second parameter;
a second communicator configured to wirelessly transmit the second detection signal;
a second memory having second instructions stored therein;
a second processor configured to execute the second instructions stored in said second memory to:
generate, based on the second parameter signal, the second detection signal; and
cause said second communicator to wirelessly transmit the second detection signal; and
a second power source configured to supply power to said second sensor, said second communicator, said second memory and said second processor.

5. The fire early detection system of claim 4,
wherein said communicator is additionally configured to wirelessly receive the second detection signal and to transmit the second detection signal,
wherein said second communicator is additionally configured to wirelessly receive the detection signal and to transmit the detection signal,
wherein said processor is additionally configured to execute the instructions stored in said memory to cause said communicator to wirelessly transmit the second detection signal, and
wherein said second processor is additionally configured to execute the second instructions stored in said second memory to cause said second communicator to wirelessly transmit the detection signal.

6. The fire early detection system of claim 1,
wherein said sensor comprises a microphone configured to detect sound, as the parameter, of the environment surrounding said sensory node at the location and to output an audio signal as the parameter signal, and
wherein said processor is additionally configured to execute the instructions stored in said memory to generate the detection signal by band-pass filtering the audio signal to eliminate any frequencies above 10 KHz and any frequencies below 100 Hz.

7. The fire early detection system of claim 1, wherein said power source is selected from the group of power sources comprising a battery, a capacitor, an energy harvesting system, a generator, and combinations thereof.

8. A method of detecting and warning of a fire, said method comprising:
detecting, via a sensor of a sensory node disposed at a location, a parameter of an environment surrounding the sensory node at the location;
outputting, via the sensor, a parameter signal based on the detected parameter;
generating, via a processor configured to execute instructions stored in a memory, based on the parameter signal, a detection signal;
causing, via the processor, a communicator to wirelessly transmit the detection signal to a gateway device;
supplying power, via a power source, to the sensor, the communicator, the memory and the processor;
wirelessly receiving, via a gateway device, the detection signal via a first communication protocol;
communicating, via the gateway device, with a warning system via a network communication protocol; and
outputting, via the warning system, a warning signal based on the detection signal.

9. The method of claim 8, wherein said detecting the parameter of the environment surrounding the sensory node at the location comprises detecting the parameter as one of a group of parameters comprising sound volume, sound frequency composition, temperature, pressure, humidity, gas composition, wind magnitude, wind direction, change in sound volume, change in sound frequency composition, change in temperature, change in pressure, change in humidity, change in gas composition, change in wind magnitude, change in wind direction, and combinations thereof.

10. The method of claim 8, further comprising:
detecting, via a second sensor of the sensory node disposed at the location, a second parameter of the environment surrounding the sensory node at the location;
outputting, via the second sensor, a second parameter signal based on the detected second parameter;
generating, via the processor, based on the parameter signal and the second parameter signal, the detection signal; and
supplying power, via the power source, to the second sensor,
wherein said detecting the parameter of the environment surrounding the sensory node at the location comprises detecting the parameter as one of a group of parameters comprising sound volume, sound frequency composition, temperature, pressure, humidity, gas composition, wind magnitude, wind direction, change in sound volume, change in sound frequency composition, change in temperature, change in pressure, change in humidity, change in gas composition, change in wind magnitude, change in wind direction, and combinations thereof, and
wherein said detecting, via the second sensor of the sensory node disposed at the location, the second parameter of the environment surrounding the sensory node at the location comprising the second parameter as another one of the group of parameters.

11. The method of claim 8, further comprising:
detecting, via a second sensor of a second sensory node disposed at a second location, a second parameter of an environment surrounding the second sensory node at the second location;
outputting, via the second sensor, a second parameter signal based on the detected second parameter;
generating, via a second processor configured to execute instructions stored in a second memory, based on the second parameter signal, a second detection signal;
causing, via the second processor, a second communicator to wirelessly transmit the second detection signal; and
supplying power, via a second power source, to the second sensor, the second communicator, the second memory and the second processor.

12. The method of claim 11, further comprising:
wirelessly receiving, via the communicator, the second detection signal; and
wirelessly transmitting, via the communicator, the second detection signal.

13. The method of claim 8,
wherein said detecting, via the sensor of the sensory node disposed at the location, the parameter of the environment surrounding the sensory node at the location comprises:
detecting, via a microphone, sound as the parameter, of the environment surrounding said sensory node at the location; and
outputting, via the microphone, an audio signal as the parameter signal, and
wherein said generating, via the processor, the detection signal comprises generating the detection signal by band-pass filtering the audio signal to eliminate any frequencies above 10 KHz and any frequencies below 100 Hz.

14. The method of claim 8, wherein said supplying power, via the power source, to the sensor, the communicator, the memory and the processor comprises supplying power via the power source being selected from the group of power sources comprising a battery, a capacitor, an energy harvesting system, a generator, and combinations thereof.

15. A non-transitory, computer-readable media having computer-readable instructions stored thereon, the computer-readable instructions being capable of being read by a fire early detection system to perform the method comprising:
detecting, via a sensor of a sensory node disposed at a location, a parameter of an environment surrounding the sensory node at the location;
outputting, via the sensor, a parameter signal based on the detected parameter;
generating, via a processor configured to execute instructions stored in a memory, based on the parameter signal, a detection signal;
causing, via the processor, a communicator to wirelessly transmit the detection signal to a gateway device;
supplying power, via a power source, to the sensor, the communicator, the memory and the processor;
wirelessly receiving, via the gateway device, the detection signal via a first communication protocol;
communicating, via the gateway device, with a warning system via a network communication protocol; and
outputting, via the warning system, the warning signal based on the detection signal.

16. The non-transitory, computer-readable media of claim 15, wherein the computer-readable instructions are capable of instructing the fire early detection system to perform the method wherein said detecting the parameter of the environment surrounding the sensory node at the location comprises detecting the parameter as one of a group of parameters comprising sound volume, sound frequency composition, temperature, pressure, humidity, gas composition, wind magnitude, wind direction, change in sound volume, change in sound frequency composition, change in temperature, change in pressure, change in humidity, change in gas composition, change in wind magnitude, change in wind direction, and combinations thereof.

17. The non-transitory, computer-readable media claim 16, wherein the computer-readable instructions are capable of instructing the fire early detection system to perform the method further comprising:
detecting, via a second sensor of the sensory node disposed at the location, a second parameter of the environment surrounding the sensory node at the location;
outputting, via the second sensor, a second parameter signal based on the detected second parameter;
generating, via the processor, based on the parameter signal and the second parameter signal, the detection signal; and
supplying power, via the power source, to the second sensor;
wherein said detecting the parameter of the environment surrounding the sensory node at the location comprises detecting the parameter as one of a group of parameters comprising sound volume, sound frequency composition, temperature, pressure, humidity, gas composition, wind magnitude, wind direction, change in sound volume, change in sound frequency composition, change in temperature, change in pressure, change in humidity, change in gas composition, change in wind magnitude, change in wind direction, and combinations thereof, and
wherein said detecting, via the second sensor of the sensory node disposed at the location, the second parameter of the environment surrounding the sensory node at the location comprising the second parameter as another one of the group of parameters.

18. The non-transitory, computer-readable media of claim 15, wherein the computer-readable instructions are capable of instructing the fire early detection system to perform the method further comprising:
detecting, via a second sensor of a second sensory node disposed at a second location, a second parameter of an environment surrounding the second sensory node at the second location;
outputting, via the second sensor, a second parameter signal based on the detected second parameter;
generating, via a second processor configured to execute instructions stored in a second memory, based on the second parameter signal, a second detection signal;
causing, via the second processor, a second communicator to wirelessly transmit the second detection signal; and
supplying power, via a second power source, to the second sensor, the second communicator, the second memory and the second processor.

19. The non-transitory, computer-readable media claim 15, wherein the computer-readable instructions are capable of instructing the fire early detection system to perform the method further comprising:
wirelessly receiving, via the communicator, the second detection signal; and
wirelessly transmitting, via the communicator, the second detection signal.

20. The non-transitory, computer-readable media claim 15, wherein the computer-readable instructions are capable of instructing the fire early detection system to perform the method
wherein said detecting, via the sensor of the sensory node disposed at the location, the parameter of the environment surrounding the sensory node at the location comprises:
detecting, via a microphone, sound as the parameter, of the environment surrounding said sensory node at the location; and
outputting, via the microphone, an audio signal as the parameter signal, and
wherein said generating, via the processor, the detection signal comprises generating the detection signal by band-pass filtering the audio signal to eliminate any frequencies above 10 KHz and any frequencies below 100 Hz.
